(19) United States
(12) Patent Application Publication
(10) Pub. No.: US 2008/0138781 A1
(43) Pub. Date: Jun. 12, 2008

(54) SURGICAL TRAINING MODEL AND METHOD FOR USE IN FACILITATING TRAINING OF A SURGICAL PROCEDURE

(75) Inventors: Henri F. PELLEGRIN, Germantown, TN (US); Chad E. MAXWELL, Lakeland, TN (US)

Correspondence Address: HESLIN ROTHENBERG FARLEY & MESITI P.C., 5 COLUMBIA CIRCLE, ALBANY, NY, 12203, US

(73) Assignee: WARSAW ORTHOPEDIC, INC., Warsaw, IN (US)

(21) Appl. No.: 11/754,788

(22) Filed: May 29, 2007

Related U.S. Application Data
(63) Continuation of application No. 11/608,307, filed on Dec. 8, 2006, now abandoned.

(51) Int. Cl. G09B 23/30

(52) U.S. Cl. 434/274

(57) ABSTRACT

A surgical training model for use in facilitating training a user of a surgical procedure. The model includes a holder member with a receptacle and an insert member configured for placement within the receptacle of the holder member. The insert member is modular relative to the holder member, thereby allowing a user of the model to dispose of the insert member following the performance of a surgical procedure. The insert member includes a portion of a human vertebral column, with the human vertebral column having an artificial bone portion and artificial soft tissue portion. The artificial bone portion and the artificial soft tissue portion are positioned proximate relative to each other to substantially mimic resistance of human vertebral bone and surrounding soft tissue. The insert member also includes a pathology structure that replicates certain disease or structural modalities. A method for manufacturing a surgical training model is also disclosed.

### CROSS-REFERENCE IS RELATED PATENT/APPLICATION

This application contains subject matter which is related to the subject matter of the following patent and published application, which are hereby incorporated herein by reference in their entirety:

“Artificial Bone,” by Mike Zeeff, U.S. Letters Patent No. U.S. Pat. No. 7,018,212 B2, issued Mar. 28, 2006; and

“Soft Tissue Model,” by Mike Zeeff, U.S. Ser. No. 10/936,214, filed Sep. 8, 2004, published on Mar. 9, 2006 as U.S. Patent Application Publication No. US 2006/0051729 A1.

### TECHNICAL FIELD

The present invention relates generally to a medical practitioner training aid, and more specifically, but not exclusively, to a surgical training model comprising a modular insert device and a holder mechanism which model one or more surgical approaches to the human spine. The training model can be utilized to demonstrate specific surgical techniques and/ or surgical implant products.

### BACKGROUND OF THE INVENTION

Anatomical reproductions and models are being utilized to replace cadaveric specimens for the surgical training of medical practitioners. The demand to practice surgical techniques and to evaluate the use of new surgical implants is increasingly important in the evolving medical field.

Typically, medical practitioners have used cadavers or alternatively, saw-bone models to practice implanting medical devices. The lack of availability of cadaveric specimens and the high costs associated with the disposal of used human specimens has decreased the demand by medical practitioners to utilize this tool for training purposes.

The alternative saw-bone models have been used increasingly to display newly developed implant devices and on which to perform practice surgical procedures. The associated low cost and ease of ordering these types of models provides the medical practitioner with an attractive alternative. The disadvantages of a saw-bone model is its lack of realistic anatomic features and soft-tissue characteristics. These limitations diminish the artificial in vivo environment that is desired by the medical practitioner when practicing a new surgical procedure or observing the implantation of a recently developed medical device.

### SUMMARY OF THE INVENTION

Advancement of the state of surgical training models is believed to be desirable. The present invention satisfies the need for improvements to the surgical training model by providing artificial bones and soft tissue that more closely replicate the physical characteristics of human tissue. Further, the design of the surgical training model is modular, thereby allowing the user to exchange various anatomic inserts to allow the medical practitioner to more closely simulate the actual pathologic conditions that may be presented in an actual human case. By employing disposable modular inserts and a single insert holder, the cost of utilization of the training model is decreased and the flexibility to provide different artificial in vivo surgical conditions is increased.

The present invention provides in one aspect, a surgical training model for use in facilitating training of a surgical procedure, the surgical training model includes a holder member having a receptacle portion and an insert member configured to be positioned within the receptacle portion of the holder member. The insert member is modular in relation to the holder member and may be disposed of following the performance of a surgical procedure with the surgical training model. The insert member is configured to mimic a portion of an anatomy of a mammal to facilitate the training of a medical practitioner in performing a surgical procedure.

The present invention provides in another aspect, a surgical training model system for use in facilitating training of at least one surgical procedure with the surgical training model including a holder member having a receptacle portion and a plurality of insert members, with multiple insert members of the plurality of insert members being configured to mimic a portion of an anatomy of a mammal, and to also be configured to be positioned within the receptacle portion of the holder member. Each of the multiple insert members are modular in relation to the holder member and are disposable following use in the performance of a surgical procedure.

The present invention provides in another aspect, a surgical training model for use in facilitating training of a surgical procedure, the surgical training model includes a holder member having a receptacle portion and an insert member having at least a portion of a human vertebral column that includes an artificial bone portion and an artificial soft tissue portion, with the artificial soft tissue portion partially surrounding the artificial bone portion. The artificial bone portion includes a plurality of vertebral body elements and intervertebral disc elements, and the artificial soft tissue portion has one or more of the following elements; an outer skin element, a subcutaneous element, a muscle element, an anterior ligamentus element, a posterior ligamentus element, a lateral ligamentus element, a vascular element and a tethered nerve root element. The artificial bone portion and artificial soft tissue portion are oriented within the insert member to produce resistance to a user performing a surgical procedure that approximates the resistance of human vertebral bone and surrounding soft tissue. The insert member is configured for placement within the receptacle portion of the holder member when in use, and is modular in relation to the holder member thus, allowing for disposal following the performance of the surgical procedure using the surgical training model.

The present invention provides in another aspect, a surgical training model system for use in facilitating the training of at least one surgical procedure, the surgical training model has a holder member that includes a receptacle portion and a plurality of insert members, with multiple insert members of the plurality of insert members being configured to mimic at least a portion of the human vertebral column including an artificial bone portion and an artificial soft tissue portion. The artificial soft tissue portion partially surrounds the artificial bone portion, with the artificial bone portion including a plurality of vertebral body elements and intervertebral disc elements. The artificial soft tissue portion includes at least one of the following elements, including, an outer skin element, a subcutaneous element, a muscle element, an anterior ligamentus element, a posterior ligamentus element, a lateral ligamentus element, a vascular element and a tethered nerve root element. The artificial bone portion and artificial soft tissue portion are oriented within the insert member to produce resistance to a user that when performing a surgical procedure approximates the resistance of human vertebral bone and surrounding soft tissue. The insert member is configured for positioning within the receptacle portion of the holder member and is modular in relation to the holder member allowing for disposal following performance of the surgical procedure using the surgical training model.

The present invention provides in another aspect, a modular insert for use in a surgical training model, the surgical training model includes a holder and a cradle, with the cradle configured to engage the modular insert and facilitate stabilizing the modular insert relative to the holder. The modular insert includes an artificial bone portion and an artificial soft tissue portion. The artificial soft tissue portion is contoured to at least partially surround the artificial bone portion and facilitate securement of the modular insert to the cradle and positioning of the modular insert within the holder.

The present invention provides in another aspect, a method of manufacturing a surgical training model, the method includes the steps of providing a holder member that includes a receptacle portion and providing an insert member that includes at least a portion of a human vertebral column having an artificial bone portion and an artificial soft tissue portion with the artificial soft tissue portion at least partially surrounding the artificial bone portion. The artificial bone portion has a plurality of vertebral body elements and intervertebral disc elements, and the artificial soft tissue portion includes at least one of the following elements, including, an outer skin element, a subcutaneous element, a muscle element, an anterior ligamentus element, a posterior ligamentus element, a lateral ligamentus element, a vascular element and a tethered nerve root element. The artificial bone portion and artificial soft tissue portion are oriented within the insert member to produce resistance to a user when performing a surgical procedure that approximates the resistance of human vertebral bone and surrounding soft tissue. The insert member is configured for positioning within the receptacle portion of the holder member when in use. Further, the insert member is modular in relation to the holder member and is disposable following the performance of the surgical procedure using the surgical training model.

Another aspect of the present invention provides a method of manufacturing a surgical training model system, the method includes the steps of providing a holder member having at least one receptacle portion and providing a plurality of insert members, with at least one of the plurality of insert members being configured to mimic at least a portion of a human vertebral column. The human vertebral column includes an artificial bone portion and an artificial soft tissue portion with the artificial soft tissue portion at least partially surrounding the artificial bone portion. The artificial bone portion includes a plurality of vertebral body elements and intervertebral disc elements. The artificial soft tissue portion includes at least one element of the following elements; an outer skin element, a subcutaneous element, a muscle element, an anterior ligamentus element, a posterior ligamentus element, a lateral ligamentus element, a vascular element and a tethered nerve root element. The artificial bone portion and artificial soft tissue portion are oriented within the insert member to produce resistance to a user when performing a surgical procedure that approximates the resistance of human vertebral bone and surrounding soft tissue. The insert member is configured for positioning within the at least one receptacle portion of the holder member and is modular in relation to the holder member, thus allowing the insert member to be disposed following performance of the surgical procedure using the surgical training model.

Another aspect of the present invention provides a method of use of a surgical training model, the method has the steps of obtaining a holder member having a receptacle portion and obtaining a plurality of insert members, with the plurality of insert members each comprising an artificial bone portion and an artificial soft tissue portion. The artificial soft tissue portion at least partially surrounds the artificial bone portion. The artificial bone portion has a plurality of vertebral body elements and intervertebral disc elements. The artificial soft tissue portion includes at least one or more of the following elements, including; an outer skin element, a subcutaneous element, a muscle element, an anterior ligamentus element, a posterior ligamentus element, a lateral ligamentus element, a vascular element and a tethered nerve root element. The artificial bone portion and artificial soft tissue portion are positioned within each insert member to produce resistance to a user when performing a surgical procedure that approximates the resistance of human vertebral bone and surrounding soft tissue. For each insert member, the plurality of vertebral body elements and the intervertebral disc elements comprise a pathology structure that includes at least one degenerative vertebral body bone modality, a trauma induced vertebral body deformity, a structural vertebral body deformity, a structural disc modality or a diseased disc modality. Each of the insert members are configured to be positioned within the receptacle portion, and is modular in relation to the holder member. The method may also include the steps of selecting the insert member and corresponding pathology structure and inserting the insert member and corresponding pathology structure into the receptacle portion of the holder member.

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features and advantages of the invention are apparent from the following detailed description taken in conjunction with the accompanying drawings in which:

FIG. 1 is a perspective view of one embodiment of a holder member of a posterior lumbrosacral surgical training model, in accordance with an aspect of the present invention;

FIG. 2 is an exploded, perspective view of an insert member and the holder member of FIG. 1 prior to the insert member being placed within the receptacle portion of the holder member, in accordance with an aspect of the present invention;

FIG. 3 is a lateral, elevational view of the insert member of FIG. 2, showing the assembled artificial bone portion and the artificial soft tissue portion, in accordance with an aspect of the present invention;

FIG. 4 is a perspective view of one embodiment of a holder member of an anterior cervical surgical training model, in accordance with an aspect of the present invention;

FIG. 5 is an anterior, perspective view of the holder member of the anterior cervical surgical training model of FIG. 4 showing a skin flap removed and exposing an outer muscle layer of an artificial soft tissue portion of an insert member, in accordance with an aspect of the present invention;

FIG. 6 is an anterior, perspective view of the insert member coupled to a cradle for the anterior cervical surgical training model of FIG. 4, in accordance with an aspect of the present invention;

FIG. 7 is an anterior, perspective view of the uncoupled cradle showing the corresponding concavities that mate with an artificial bone portion and the artificial soft tissue portion of the insert member for the anterior cervical surgical training model, in accordance with an aspect of the present invention;

FIG. 8 is an exploded, perspective view of the anterior cervical surgical training model with the cradle, insert member and the holder member of FIG. 4, prior to the insert member being coupled to the cradle and then, being placed within a receptacle portion of the holder member, in accordance with an aspect of the present invention;

FIG. 9 is an inferior, perspective view of one embodiment of a holder member of an anterior lumbrosacral surgical training model with a skin flap in place, in accordance with an aspect of the present invention;

FIG. 10 is an inferior, perspective view of the holder member of the anterior lumbrosacral surgical training model of FIG. 9 showing a skin flap removed and exposing a vascular element of an artificial soft tissue portion of an insert member, in accordance with an aspect of the present invention;

FIG. 11 is an exploded, perspective view of the anterior lumbrosacral surgical training model with the cradle, insert member and the holder member of FIG. 9, prior to the insert member being coupled to the cradle and then, being placed within a receptacle portion of the holder member, in accordance with an aspect of the present invention;

FIG. 12 is a posterior, elevational view of a pelvis, ribs and an abnormally laterally curved spinal column that may be replicated by a pathology structure, in accordance with an aspect of the present invention; and

FIG. 13 is a lateral, elevational view of a pelvis, ribs and spinal column exhibiting an abnormal kyphotic curvature of the thoracic spine that may be replicated by a pathology structure, in accordance with an aspect of the present invention.

### BEST MODE FOR CARRYING OUT THE INVENTION

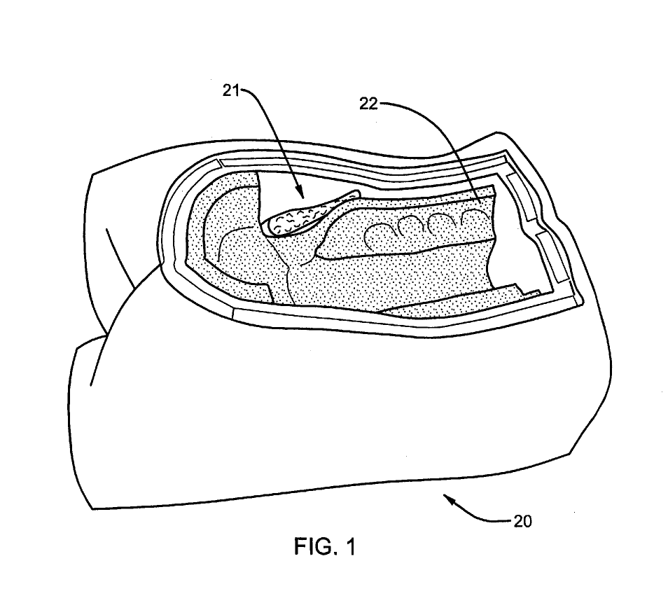

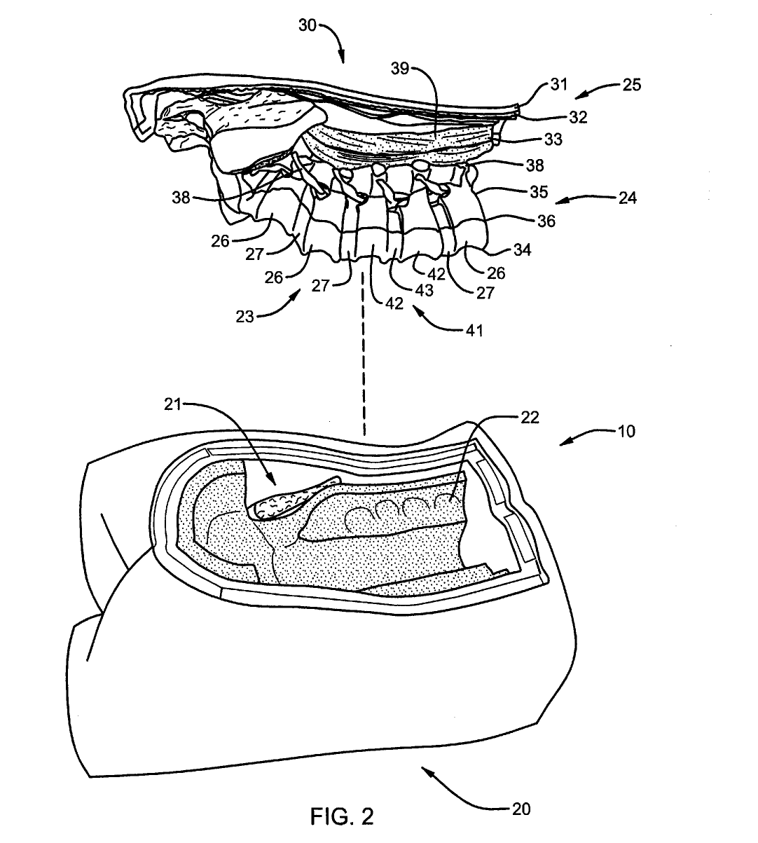

Referring to FIGS. 1 & 2, one embodiment of a surgical training model 10 (see FIG. 2) is shown, in accordance with an aspect of the present invention. As shown in FIG. 2, model 10 includes a holder member 20 and an insert member 30. Holder member 20 includes a receptacle portion 21 configured to receive insert member 30. The shape of insert member 30 partially mates with at least one inner surface 22 of receptacle portion 21 when insert member 30 is placed within receptacle portion 21. Following assembly of insert member 30 into receptacle portion 21, the exterior appearance of holder member 20 closely approximates the posterior aspect of a lower torso of a human body. Insert member 30 is usually held in place within receptacle portion 21 by material friction, although it should be understood to those skilled in the art that other securement mechanisms are contemplated including, but not limited to velcro, removable adhesives and mechanical means. As seen in FIG. 1, the concave receptacle portion 21 of holder member 20 is sized and shaped to accommodate the exterior shape of insert member 30. When assembled, surgical training model 10 (shown in FIG. 2) allows a medical practitioner to perform surgical procedures utilizing what is know in the art as a posterior lumbrosacral approach.

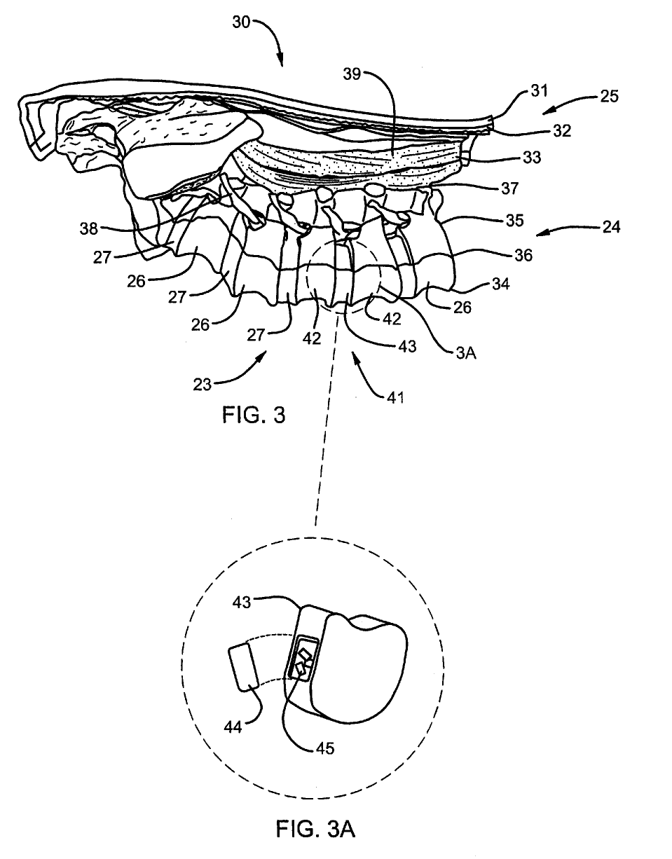

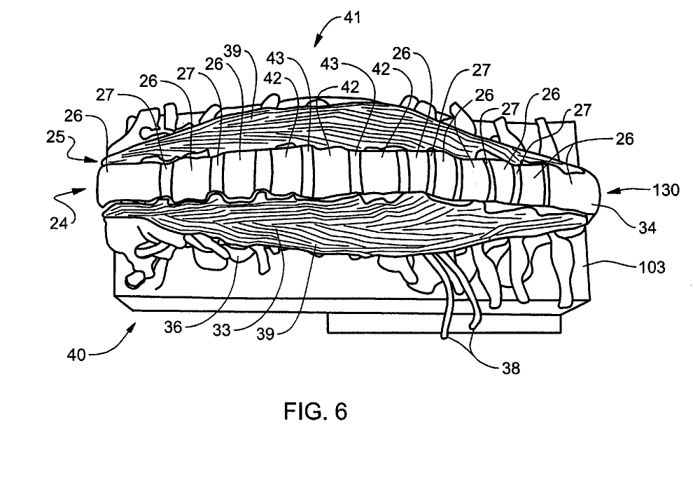

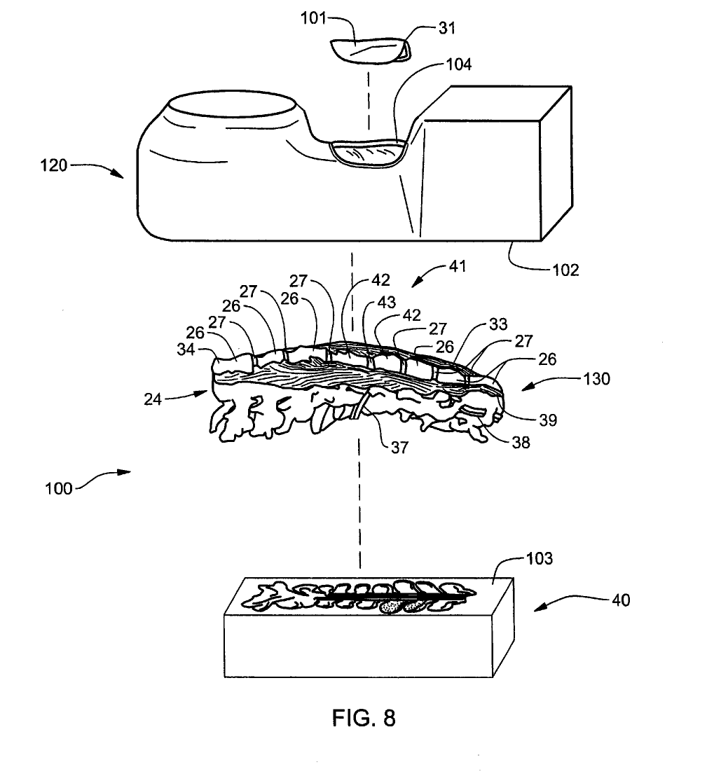

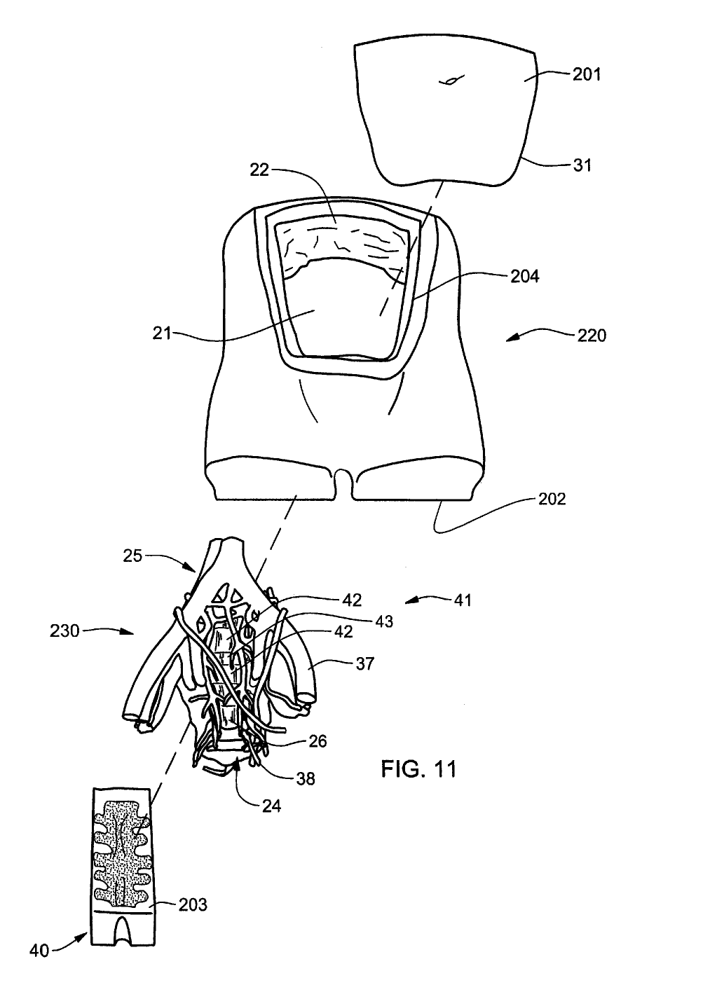

As shown in FIGS. 3, 6, 8 and 11, insert member 30, 130, 230 includes a replica of a human vertebral column 23. Vertebral column 23 exhibited in FIG. 3 is a segment that mimics the human lumbar spine and sacral spine segments. Wherein, vertebral column 23 in FIGS. 6 and 8 mimic the cervical spine and for FIG. 11, vertebral column 23 mimics the lumbrosacral spine segment. It should be understood to those skilled in the art that other spine segments may be replicated and utilized with insert member 30. These may include, the cervical-thoracic spine, the thoracic spine and the sacral-coccyx junction segment. Vertebral column 23 includes an artificial bone portion 24 and an artificial soft-tissue portion 25. Artificial bone portion 24 may include one or several vertebral body elements 26 with intervertebral disc elements 27 positioned between each of vertebral body elements 26. It should be understood to those skilled in the art that vertebral body elements 26 may also be referred to as a vertebra or vertebrae (if multiple) and may be comprised of several additional structures, including but not limited to facets, facet capsules, transverse processes, spinous processes, lamina, and pedicles. Vertebral body elements 26 and the vertebral body 42 may be fabricated from a polymeric material. Examples of such polymeric material include polyethylene, polystyrene and acrylic. The fabrication method utilized to manufacture vertebral body elements 26 and vertebral body 42 includes various pressure and temperate ranges that allow for the formation of two regions within vertebral body elements 26 and vertebral body 42. The resulting regions may include a bone shell portion that exhibits physical properties substantially similar to those of cortical bone and a bone core portion that has physical properties that are close to human cancellous bone. In addition, a material additive may be incorporated during the fabrication method of vertebral body elements 26 and vertebral body 42 that results in enhanced radiography of artificial bone portion 24. Generally, radiographs will more clearly show artificial bone portion 24 relative to its anatomic position within surgical training model 10.

Intervertebral disc elements 27, 43 may be fabricated from an elastomer material. Examples of the elastomeric material include urethane, rubber, silicone and polyolefin. Intervertebral disc elements 27, 43 are generally manufactured utilizing a process that results in the nucleus portion 45 and the annulus portion 44 each having a Shore A hardness range of 5 to 90A, with a more detailed range being of 10 to 20A.

As seen in FIG. 3, artificial soft-tissue portion 25 is a matrix-like structure which includes closely placed layers of various structure elements. Such structure elements may be colored or dyed in manner to provide the user of surgical training model 10 with the ability to identify individual anatomic features of insert member 30 specifically within the vicinity of the surgical site. The various structure elements that comprise artificial soft-tissue portion 25 may include an outer skin element 31, a subcutaneous tissue or fascia element 32, several different muscle elements 33, an anterior ligamentus structure element 34, a posterior ligamentus structure element 35, lateral oriented ligamentus elements 36, vascular elements 37 including veins and arteries and tethered nerve root elements 38. Artificial soft-tissue portion 25 can be manufactured from an elastomeric material. Examples of elastomeric materials that may be used include urethane, silicone and polyolefin. The manufacturing process for producing artificial soft-tissue portion 25 generally results in producing elements with varying Shore A hardness values. For example purposes only, the dura mater, subcutaneous and fascia elements 32 may have a value range of 5 to 90A, with a more detailed example being a range of 15 to 25A. Skin element 31 may have a range of 10 to 20A and the muscle element 33 may have a range of 10 to 90A. The ligamentus structure elements 34, 35, 36 may have a range generally from 5 to 90A, with a more detailed range being 15 to 25A. The vascular and nerve elements 37, 38 may also have a range from 5 to 90A, with a more specific example being a range of 10 to 20A.

As exhibited in FIG. 3, muscle element 33 incorporates into its outer structure numerous cuts or striations 39 that mimic the natural plane angles seen in human skeletal muscles. Striations 39, in combination with the elastomeric material used to fabricate muscle element 33 provide the user of surgical training model 10 with the look and feel of a skeletal muscle in-vivo. This look and feel characteristic includes the natural lubrication phenomena experienced by a medical practitioner when a muscle structure is cut in situ. In practice, muscle element 33 in combination with at least one of the other above listed soft-tissue elements 31, 32, 34, 35, 36, 37, 38 that comprise artificial soft tissue portion 25, are configured or oriented and positioned relative to each other to achieve an aggregate resistance to surgical manipulation that is substantially the same resistance a medical practitioner would experience when cutting or retracting soft tissue structures that surround the human spinal column during an operative procedure.

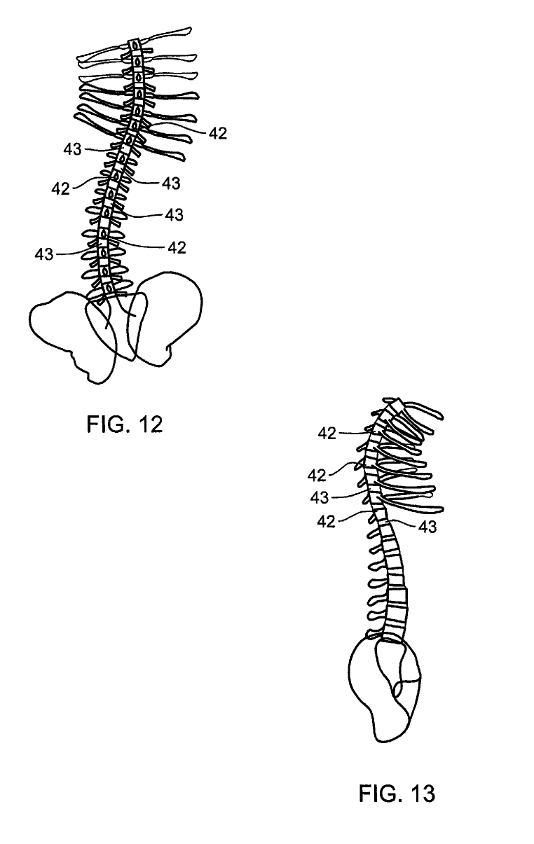

Each insert member 30 will usually include in addition to artificial bone portion 24 and artificial soft tissue portion 25, a pathology structure 41. Pathology structure 41 generally includes at least one vertebral body 42, and at least one intervertebral disc element 43. It should be understood to those skilled in the art that vertebral body 42 may also be referred to as a vertebra or vertebrae (if multiple) and may be comprised of several additional structures including, but not limited to facets, facet capsules, transverse processes, spinous processes, lamina and pedicles. Each pathology structure 41 may be constructed to replicate an actual disease or abnormal structural state that a user may be presented with clinically. For example purposes only, vertebral bodies 42 may be structurally modified to replicate the clinical conditions of degenerative osteophyte formation, osteoporosis, congenital malformations, injury from trauma or spondololisthesis. As shown in FIGS. 11 and 12, vertebral bodies 42 may also be structurally modified to exhibit clinical skeletal deformities similar to anterior, posterior and lateral stenosis, kyphosis, scoliosis and Scheuermann disease.

Further, intervertebral disc element 43 may be structurally modified to replicate various structural or disease based pathologies including, but not limited to, disc collapse, disc rupture and disc slippage. As shown in FIG. 3A, intervertebral disc element 43 of pathology structure 41 may be constructed to include annulus portion 44 and nucleus portion 45. As discussed previously herein, annulus portion 44 and nucleus portion 45 may be fabricated from an elastomer material. In combination, annulus portion 44 and nucleus portion 45 may mimic the physical characteristics of a degenerative human disc. Nucleus portion 45 generally has a composite-like structure that may include multiple imbedded particulates or polygonal bodies (not shown). Depending upon the fabrication process, the composite-like structure allows the medical practitioner to experience various degenerative states of intervertebral disc element 43 while placed within pathology structure 41 during the performance of a surgical procedure.

As depicted in FIGS. 2, 8 and 11, insert member 30, 130, 230 is modular in design relative to holder member 20, 120, 220. Thus, a user may interchange various insert members 30 with a single holder member 20. In practice, because of the modular design, a user may choose from a wide selection of multiple insert members 30 and corresponding integral pathology structures 41 to customize and construct a surgical training model that represents a certain clinical situation. For example, a user may want to choose insert member 30 and corresponding pathology structure 41 that is constructed to replicate a ruptured disc. Because insert member 30 is modular, insert member 30 that includes a pathology structure 41 with the ruptured disc may be exchanged for insert member 30 that has a different clinical presentation that is not desired by the user. The modular design of insert member 30 allows the user to utilize one holder member 20 with multiple, separate insert members 30. Generally, insert members 30 will be discarded following the performance of a surgical procedure, though it is contemplated that insert member 30 and pathology structure 41 may be reused for multiple surgeries. It should be understood to those skilled in the art that a one piece surgical training model is contemplated for all of the embodiments of the surgical training model described herein, wherein holder member 20 and insert member 30 may be constructed from a single unitary body with distinct anatomic elements being exchanged following the performance of a surgical procedure or alternatively, the entire unitary body may be exchanged or discarded following the completion of the surgical training session.

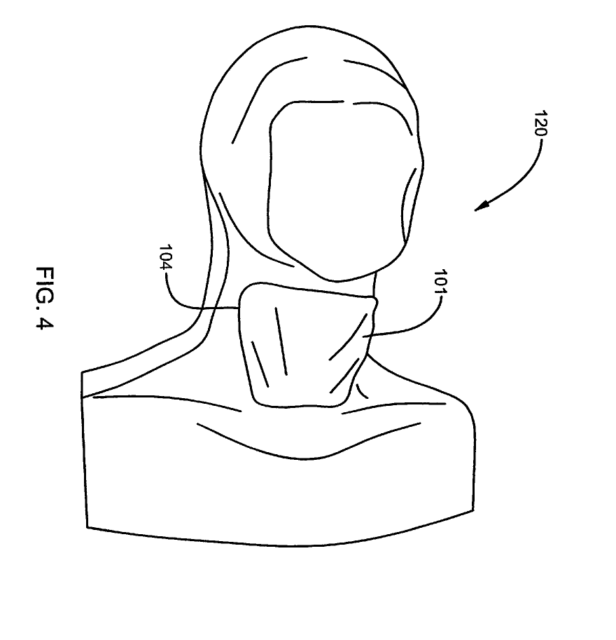

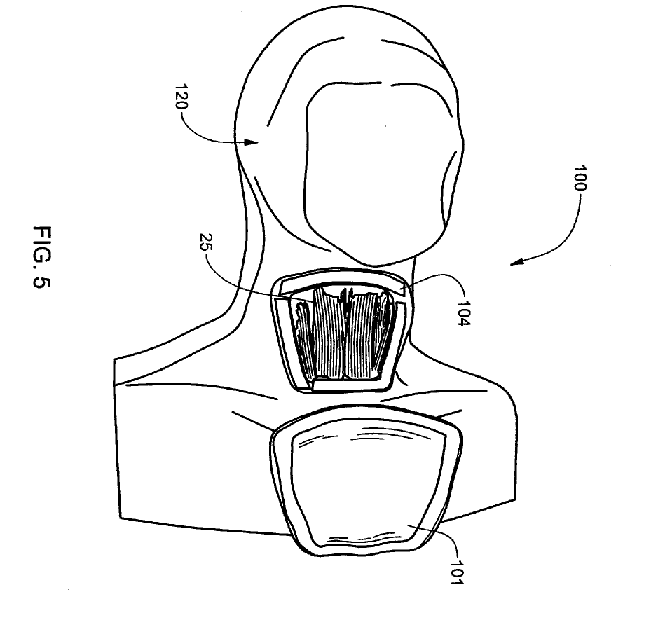

FIG. 4 shows an alternative embodiment of a surgical training model 100 with a holder element 120 and a skin flap 101 in place, in accordance with an aspect of the present invention. As depicted in FIG. 8, model 100 includes a holder member 120, an insert member 130, a cradle 40 and skin flap 101. The embodiment of surgical training model 100 shown in FIGS. 4, 5 and 8 allows the medical practitioner to perform surgical procedures utilizing, what is know in the art as an anterior cervical approach to gain access to the anterior aspect of the cervical spine. As seen in FIGS. 4 and 5, such access is gained by making surgical incision along the anterior aspect of the neck through skin flap 101. The medical practitioner may then dissect the various neck structures and associated soft tissue until the anterior portion of cervical spine is exposed. The elements of surgical training model 100 designated by the same numerals are much the same as those elements which were previously described hereinabove for surgical training model 10 of FIG. 2, thus for the sake of brevity and redundancy, these elements and their respective structural characteristics will not be discussed again for surgical training model 100.

Holder member 120 includes a receptacle portion (not shown) on a back surface 102 of the holder member 120 that is shaped and sized to receive insert member 130 and cradle 40. The outside configuration of insert member 130 partially mates within at least one inner surface (not shown) of receptacle portion when insert member 130 is placed within the receptacle portion. Following the placement of insert member 130 and cradle 40 into the receptacle portion, the exterior appearance of holder member 120 may closely approximate the head, neck and upper torso of a human body. As shown in FIG. 5, following placement of insert member 130 into the receptacle portion, artificial soft tissue portion 25 may be visualized through a neck port 104.

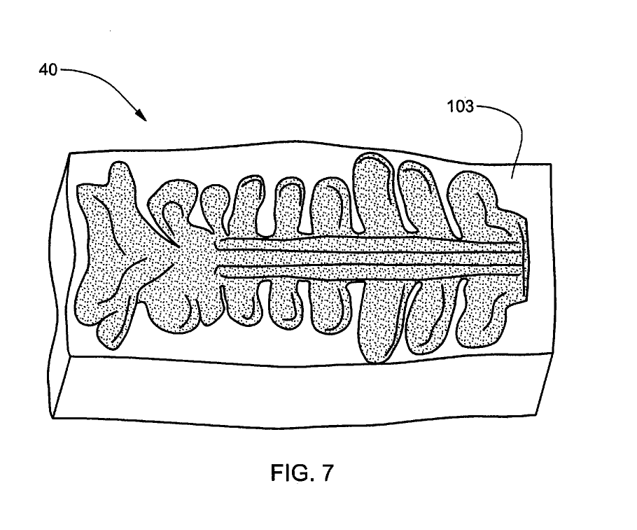

As shown in FIG. 8, insert member 130 is held in place within the receptacle portion by coupling to supporting cradle 40. FIG. 6 shows insert member 130 positioned proximate to top surface 103 of cradle 40 with cradle 40 providing structural support and stability to insert member 130 when the insert member-cradle assembly is placed within the receptacle portion of holder member 120. Cradle 40 is typically fabricated from an elastomer or polymeric material. The material ultimately chosen depends upon the desired stiffness of insert member 130 and pathology structure 41 that is utilized. As depicted in FIG. 7, cradle 40 may have several concavities on top surface 103 that generally correspond with the exterior topography of artificial bone portion 24 and soft tissue portion 25 of insert member 130. Insert member 130 and cradle 40 may be frictionally coupled, although it should be understood to those skilled in the art that other coupling mechanisms are contemplated including, but not limited to velcro, removable adhesives and mechanical means.

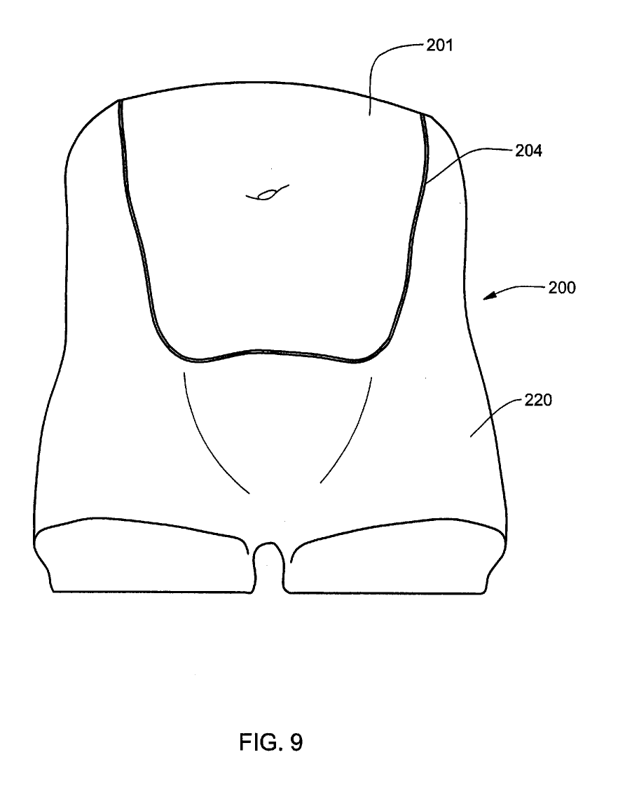

FIGS. 9, 10 and 11 depict yet another embodiment of a surgical training model 200, in accordance with an aspect of the present invention. Specifically, FIG. 9 shows surgical training model 200 including a holder element 220 and a skin flap 201 positioned within an abdominal port 204. As seen in FIG. 11, the model includes a holder member 220, an insert member 230, a cradle 40 and skin flap 201. The embodiment of surgical training model 200 shown in FIGS. 9, 10 and 11 provides the medical practitioner with the ability to perform surgical procedures utilizing, what is know in the art as, an anterior abdominal approach to gain access to the anterior aspect of the lumbrosacral spine segment.

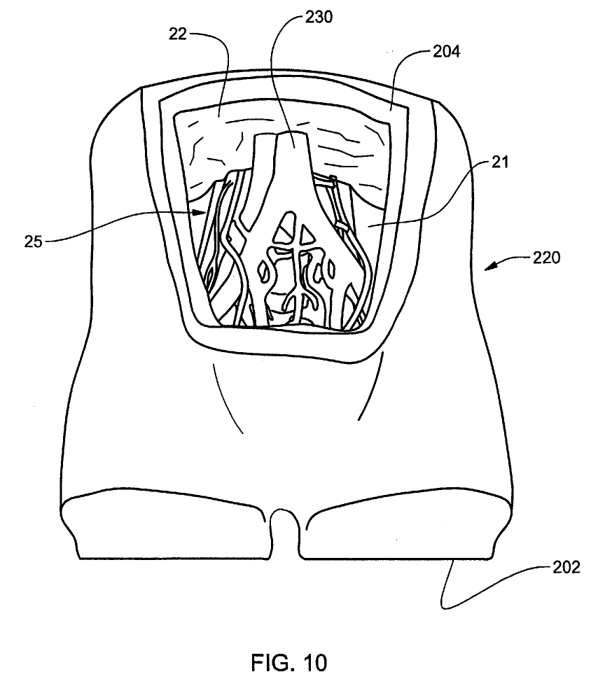

As depicted in FIGS. 9 and 10, such access is gained by making a surgical incision on the anterior aspect of the abdomen through skin flap 201. The medical practitioner may then dissect around the various abdominally-located organs, vascular structures and associated soft tissue until the anterior portion of the lumbrosacral spine is exposed. It should be noted that the structure of elements of surgical training model 200 designated by the same numerals are much the same as those elements which were previously described hereinabove for surgical training models 10 (FIG. 2) and 100 (FIG. 8), thus for the sake of brevity and to avoid redundancy, these elements will not be further discussed for surgical training model 200.

Holder member 220 includes a receptacle portion 21 located within the back surface 202 of holder member 220, that is configured to receive insert member 230 and cradle 40. As seen in FIG. 11, following placement with receptacle 21, the external configuration of insert member 230 contacts at least one inner surface 22 of receptacle portion 21 when insert member 230 is placed within receptacle portion 21. Following the placement of the insert member-cradle assembly into receptacle portion 21 and the placement of skin flap 201 over the abdominal port 204, the exterior appearance of holder member 220 may closely approximate the lower abdominal region of a human body. As shown in FIG. 10, after the insert member-cradle assembly is placed within the receptacle portion 21, artificial soft tissue portion 25 may be visualized through abdominal port 204 after skin flap 201 is cut.

As depicted in FIG. 11 and described previously herein, insert member 230 is held in place within receptacle portion 21 by coupling to supporting cradle 40 or alternatively, insert member 230 may be integral to cradle 40. Generally, insert member 230 is proximate to the top surface 203 of cradle 40. Cradle 40 functions to provide structural support and stability to insert member 230 when the insert member-cradle assembly is placed within receptacle portion 21 of holder member 220. The support, stiffness and stability provided by cradle 40 in conjunction with insert member 230 is necessary in order for surgical training model 200 to provide the realistic surgical feel that the medical practitioner is seeking when utilizing surgical training model 200. Cradle 40 may be fabricated from an elastomer or polymeric material. The material ultimately chosen for cradle 40 construction depends upon the desired stiffness of insert member 230 and pathology structure 41 that will be utilized. Generally, as described previously herein, cradle 40 has concavities on a top surface 203 that correspond with the external topography of artificial bone portion 24 and may also match that of soft tissue portion 25 of insert member 230 as shown in FIG. 11. Insert member 230 and cradle 40 are frictionally coupled together, although it should be understood to those skilled in the art that other coupling mechanisms are contemplated including, but not limited to velcro, removable adhesives and mechanical means. Although not shown, it is contemplated that for surgical training model 200, the insert member-cradle assembly may be a unitary one-piece construct.

It is further contemplated by the inventors that an alternative to the multiple modular design described herein for surgical training models 10, 100 and 200, a one piece apparatus may be utilized for the holder member and insert member. Although not shown, it should be understood to those skilled in the art that a modular pathology structure may be used with a one piece holder-insert apparatus. Further, it is also contemplated that a single structure may be used and will incorporate all elements of the holder, insert and pathology structure, thereby allowing the user to dispose of the single piece structure following the performance of a surgical procedure.

Surgical training models 10, 100 and 200 may also be available as a system, wherein the system includes a single holder member 20, 120, 220 and a plurality or series of different insert members 30, 130, 230 and if appropriate, a corresponding plurality of cradles 40. It should be understood to those skilled in the art that each of the plurality of insert members 30, 130, 230 may include a different pathology structure 41. The system, because of the modular relationship between holder member 20, 120, 220 and insert member 30, 130, 230 would allow the medical practitioner to typically use one holder member 20, 120, 220 and obtain multiple insert members 20, 130, 230 with corresponding multiple and different pathology structures 41 as has been previously described herein. This system would provide the medical practitioner with several clinical presentations as replicated by the corresponding pathology structures 41 on which to train in a single setting.

The method of manufacturing a surgical training model 10, 100, 200 includes, providing holder member 20, 120, 220 that includes receptacle portion 21 and also providing insert member 30, 130, 230 which has at least a portion of a human vertebral column 23 with artificial bone portion 24 and artificial soft tissue portion 25 that at least partially surrounds artificial bone portion 24. Artificial bone portion 24 is further comprised of a plurality of vertebral body elements 26 and intervertebral disc elements 27. Artificial soft tissue portion 25 has at least one of the elements listed, including, but not limited to, an outer skin element 31, a subcutaneous or fascia element 32, a muscle element 33, an anterior ligamentus element 34, a posterior ligamentus element 35, a lateral ligamentus element 36, a vascular element 37 and a tethered nerve root element 38. Artificial bone portion 24 and artificial soft tissue portion 25 may be oriented to produce resistance to a user performing a surgical procedure that closely approximates the resistance of human vertebral bone and surrounding soft tissue. Insert member 30, 130, 230 is also configured for placement within receptacle portion 21 of holder member 20, 120, 220 when in use, and is modular in relation to holder member 20, 120, 220, allowing it to be disposable following the performance of the surgical procedure.

The method may further include the step of providing cradle 40 with cradle 40 being configured to couple to insert member 30, 130, 230 to facilitate stability and stiffness of insert member 30, 130, 230 when placed within receptacle portion 21 of holder member 20, 120, 220. It is further understood that the method may include coupling insert member 30, 130, 230 to cradle 40 in some manner. The method may also include the step of positioning cradle 40 and insert member 30, 130, 230 within receptacle portion 21 of holder member 20, 120, 220.

The method of manufacturing a surgical training model system may include the step of providing holder member 20, 120, 220, each having at least one receptacle portion 21 and providing a plurality of insert members 30, 130, 230 with at least one of the plurality of insert members 30, 130, 230 being configured to mimic at least a portion of a human vertebral column 23, including an artificial bone portion 24 and an artificial soft tissue portion 25 with the artificial soft tissue portion 25 at least partially surrounding the artificial bone portion 24. Artificial bone portion 24 further includes a plurality of vertebral body elements 26 and intervertebral disc elements 27. The artificial soft tissue portion 25 has at least one element of the following elements: an outer skin element 31, a subcutaneous or fascia element 32, a muscle element 33, an anterior ligamentus element 34, a posterior ligamentus element 35, a lateral ligamentus element 36, a vascular element 37 and a tethered nerve root element 38. Artificial bone portion 24 and artificial soft tissue portion 25 are oriented to generally produce a resistance to the user when performing a surgical procedure that is approximately the same resistance of human vertebral bone and surrounding soft tissue. Further, insert member 30, 130, 230 is configured for positioning within the at least one receptacle portion 21 of holder member 20, 120, 220 and is modular in relation to holder member 20, 120, 220, thus may be disposable following the performance of the surgical procedure.

The method of manufacturing a surgical training model system may further include the step of providing at least one cradle 40, with each cradle 40 of the at least one cradle 40 being configured to couple to insert member 30, 130, 230 to facilitate stability and stiffness of insert member 30, 130, 230 when placed within receptacle portion 21 of holder member 20, 120, 220. The method may also include coupling each insert member 30, 130, 230 to cradle 40. It is understood that the method may include the step of positioning cradle 40 and insert member 30, 130, 230 into at least one receptacle portion 21 of holder member 20, 120, 220. Further, at least one insert member 30,130, 230 of the plurality of insert members 30, 130, 230 has at least one pathology structure 41 with the at least one pathology structure including at least one vertebral body element 42 and the at least one vertebral body element 42 includes at least one of a degenerative bone modality, a trauma induced deformity or a structural deformity. Additionally, the at least one insert member 30, 130, 230 may be multiple insert members 30, 130, 230 and the at least one pathology structure 41 may also include for each insert member 30, 130, 230 of the multiple insert members 30, 130, 230, at least one intervertebral disc element 43. The at least one intervertebral disc element 43 has at least one of a structural or a disease modality. The at least one insert member 30, 130, 230 is usually multiple insert members 30, 130, 230 and the at least one pathology structure 41 is typically multiple pathology structures 41, with each of the multiple pathology structures 41 having a different disease modality, including but not limited to, a degenerative bone modality, a trauma induced deformity, a structural deformity or a systemic disease modality. Additionally, each of the insert members 30, 130, 230 have a different pathology structure 41 and are modular relative to holder member 20, 120, 220, thereby allowing the user to select a pathology structure 41 for performing the surgical procedure.

A method of use of surgical training model 10, 100, 200 includes, obtaining holder member 20, 120, 220 having at least one receptacle portion 21 and obtaining a plurality of insert members 30, 130, 230, with each of the plurality of insert members 30, 130, 230 including an artificial bone portion 24 and an artificial soft tissue portion 25. The artificial soft tissue portion 25 at least partially surrounding artificial bone portion 24. Artificial bone portion 24 includes a plurality of vertebral body elements 26 and intervertebral disc elements 27. Artificial soft tissue portion 25 further includes at least one element of the following elements; an outer skin element 31, a subcutaneous or fascia element 32, a muscle element 33, an anterior ligamentus element 34, a posterior ligamentus element 35, a lateral ligamentus element 36, a vascular element 37 and a tethered nerve root element 38. Artificial bone portion 24 and artificial soft tissue portion 25 are positioned within insert member 30, 130, 230 to produce resistance to a user when performing a surgical procedure that closely approximates the resistance of human vertebral bone and surrounding soft tissue. It is also understood that for each insert member 30, 130, 230, the plurality of vertebral body elements 42 and intervertebral disc elements 43 comprise pathology structure 41 that has at least one clinical condition, including but not limited to, a degenerative vertebral body, a trauma induced injury body deformity, a structural or spinal column deformity, a structural disc condition (e.g., ruptured, collapsed or slippage) and a diseased disc modality. Further, each insert member 30, 130, 230 is configured to be positioned within one of at least one receptacle portion 21 and is modular in relation to holder member 20, 120, 220.

The method may further include selecting insert member 30, 130, 230 and corresponding pathology structure 41 and then positioning insert member 30, 130, 230 and corresponding pathology structure 41 within corresponding receptacle portion 21 of holder member 20, 120, 220. The method of use may include the user cutting artificial soft tissue portion 25 of insert member 30, 130, 230, retracting artificial soft tissue portion 24 to expose artificial bone portion 25 and pathology structure 41, exposing artificial bone portion 24 and pathology structure 41, removing pathology structure 41, inserting or implanting a spinal implant into artificial bone portion 24, and removing and disposing or exchanging insert member 30, 130, 230 after completing the surgical procedure.

Although the preferred embodiments have been depicted and described in detail herein, it will be apparent to those skilled in the relevant art that various modifications, additions and substitutions can be made without departing from its essence and therefore these are to be considered to be within the scope of the following claims.

1. A surgical training model for use in facilitating training of a surgical procedure, the surgical training model comprising:
a holder member having a receptacle portion; and
an insert member configured to be positioned within the receptacle portion of the holder member, the insert member being modular in relation to the holder member and disposable following performance of a surgical procedure using the surgical training model, and wherein the insert member is configured to mimic a portion of an anatomy of a mammal to facilitate training of the surgical procedure.

2. The surgical training model of claim 1, wherein the insert member is sized to be tightly coupled within the receptacle portion of the holder member, and wherein the insert member aligns with the holder member to replicate to a user an external configuration of a portion of the mammal.

3. (canceled)

4. (canceled)

5. The surgical training model of claim 1, wherein the mammal is a human.

6. The surgical training model of claim 1, wherein the portion of the anatomy comprises at least a portion of a human vertebral column.

7. (canceled)

8. The surgical training model of claim 6, wherein the at least a portion of a human vertebral column comprises an artificial bone portion with an artificial soft tissue portion surrounding the artificial bone portion.

9. (canceled)

10. (canceled)

11. The surgical training model of claim 8, wherein the artificial bone portion comprises a plurality of vertebral body elements and intervertebral disc elements.

12. The surgical training model of claim 8, wherein the artificial soft tissue portion comprises one or more of an outer skin element, a subcutaneous element, a muscle element, an anterior ligamentus element, a posterior ligamentus element, a lateral ligamentus element, a vascular element or a tethered nerve root element.

13. (canceled)

14. The surgical training model of claim 11, wherein the intervertebral disc elements further comprise an annulus portion and a nucleus portion, the annulus portion and nucleus portion being oriented within the intervertebral disc elements to produce resistance for a user when performing the surgical procedure that approximates the resistance of a degenerative disc.

15. A surgical training model system for use in facilitating training of at least one surgical procedure, the surgical training model comprising:
a holder member having a receptacle portion; and
a plurality of insert members, wherein multiple insert members of the plurality of insert members are configured to mimic a portion of an anatomy of a mammal, and are configured to be positioned within the receptacle portion of the holder member, the multiple insert members each being modular in relation to the holder member and being disposable following use thereof in performance of a surgical procedure.

16. (canceled)

17. (canceled)

18. The surgical training model system of claim 15, wherein the multiple insert members each comprise an artificial bone portion, and wherein the artificial bone portion comprises at least one vertebra.

19. The surgical training model system of claim 18, wherein for each of the multiple insert members, the at least one vertebra comprises at least one of a degenerative bone modality, a trauma induced deformity or a structural deformity.

20. (canceled)

21. (canceled)

22. The surgical training model system of claim 15, wherein the multiple insert members are interchangeable within the receptacle portion of the holder member.

23. The surgical training model system of claim 15, wherein the anatomy comprises at least one intervertebral disc, the at least one intervertebral disc comprising an annulus portion and a nucleus portion, the annulus portion and nucleus portion being oriented within the at least one intervertebral disc to produce resistance to a user when performing the surgical procedure that approximates the resistance of a degenerative disc.

24. A surgical training model for use in facilitating training of a surgical procedure, the surgical training model comprising:
a holder member having a receptacle portion; and
at least one insert member comprising at least a portion of an artificial human vertebral column including an artificial bone portion and an artificial soft tissue portion at least partially surrounding the artificial bone portion, the artificial bone portion comprising a plurality of vertebral body elements and intervertebral disc elements, and the artificial soft tissue portion comprising at least one of an outer skin element, a subcutaneous element, a muscle element, an anterior ligamentus element, a posterior ligamentus element, a lateral ligamentus element, a vascular element or a tethered nerve root element, the artificial bone portion and artificial soft tissue portion being oriented within the insert member to produce resistance to a user when performing a surgical procedure that approximates resistance of human vertebral bone and surrounding soft tissue, the insert member being configured for positioning within the receptacle portion of the holder member when in use, and being modular in relation to the holder member and being disposable following performance of the surgical procedure using the surgical training model.

25. The surgical training model of claim 24, wherein the at least one insert member further comprises a pathology structure.

26. The surgical training model of claim 25, wherein the pathology structure comprises at least one vertebral body element of the artificial bone portion, wherein the at least one vertebral body element includes at least one of a degenerative bone modality, a trauma induced deformity or a structural deformity.

27. The surgical training model of claim 25, wherein the pathology structure comprises at least one intervertebral disc element of the artificial bone portion, with the at least one intervertebral disc element comprising at least one of a structural or a disease modality.

28-32. (canceled)

33. A modular insert for use in a surgical training model, the surgical training model including a holder configured to engage receive the modular insert, the modular insert comprising:
an artificial bone portion; and
an artificial soft tissue portion, the artificial soft tissue portion being contoured to at least partially surround the artificial bone portion and facilitate securement and positioning of the modular insert within the holder.

34. The modular insert of claim 33, wherein the artificial bone portion comprises a plurality of vertebral body elements and intervertebral disc elements, the plurality of vertebral body elements and intervertebral disc elements defining at least a portion of a human vertebral column.

35-38. (canceled)

39. The modular insert of claim 33, wherein the artificial soft tissue portion comprises one or more of an outer skin element, a fascia element, a subcutaneous element, a muscle element, an anterior ligamentus element, a posterior ligamentus element, a lateral ligamentus element, a vascular element or a tethered nerve root element.

40-42. (canceled)

43. The modular insert of claim 39, wherein artificial soft tissue portion comprises the muscle element, the muscle element being configured to mimic human skeletal muscle.

44. (canceled)

45. The modular insert of claim 39, wherein the outer skin element, the fascia element, the subcutaneous element, the muscle element, the anterior ligamentus element, the posterior ligamentus element, the lateral liganentus element, the vascular element and the tethered nerve root element are positioned proximate to each other within the modular insert to produce resistance for a user performing a surgical procedure with the surgical training model that approximates resistance of human soft tissue surrounding at least a portion of a human vertebral column.

46. The modular insert of claim 34, wherein the intervertebral disc elements further comprise an annulus portion and a nucleus portion, the annulus portion and nucleus portion being oriented within the intervertebral disc elements to produce resistance for a user when performing the surgical procedure that approximates the resistance of a degenerative disc.

47-58. (canceled)

59. A method of use of a surgical training model, the method comprising:
obtaining a holder member having a receptacle portion;
selecting at least one insert member, wherein the at least one insert member each comprises an artificial bone portion and an artificial soft tissue portion at least partially surrounding the artificial bone portion, the artificial bone portion comprising at least one vertebral body element and intervertebral disc element, and the artificial soft tissue portion comprising one or more of an outer skin element, a subcutaneous element, a muscle element, an anterior ligamentus element, a posterior ligamentus element, a lateral ligamentus element, a vascular element or a tethered nerve root element, wherein the artificial bone portion and artificial soft tissue portion are disposed within an insert member to produce resistance to a user when performing a surgical procedure with the surgical training model that approximates resistance of human vertebral bone and surrounding soft tissue, wherein the vertebral body element and intervertebral disc element comprise a pathology structure comprising at least one of a degenerative vertebral body bone modality, a trauma induced vertebral body deformity and a structural spine segment deformity, a disc structural modality or a diseased disc modality, and wherein the at least one insert member is configured to be positioned within the receptacle portion, and is modular in relation to the holder member; and
inserting the at least insert member with selected pathology structure into the receptacle portion of the holder member.

60. The method of claim 59, further comprising cutting the artificial soft tissue portion of the insert member during the performance of the surgical procedure.

61. The method of claim 60, further comprising retracting the artificial soft tissue portion to expose the artificial bone portion and pathology structure.

62. (canceled)

63. The method of claim 61, further comprising removing the pathology structure.

64. The method of claim 60, further comprising inserting a spinal implant into engagement with the artificial bone portion.

65. The method of claim 59, further comprising removing and disposing of the insert member after completing the surgical procedure using the surgical training model.

66. The surgical training model of claim 25, comprising a plurality of insert members, wherein at least a first insert member and a second insert member comprise different pathology structures.
